(19) United States
(12) Patent Application Publication
(10) Pub. No.: US 2010/0197836 A1
(43) Pub. Date: Aug. 5, 2010

(54) Metal Rich Coatings Compositions

(76) Inventors: Craig Price, Lexington Park, MD (US); Craig Matzdorf, California, MD (US); William Nickerson, California, MD (US); Edward Lipnickas, Lexington Park, MD (US)

Correspondence Address: Department of the Navy;(Naval Air Warfare Center -Aircraft Division), 47076 Lijencreantz Road, B 435, PATUXENT RIVER, MD, 20670, US

(21) Appl. No.: 12/364,540

(22) Filed: Feb. 3, 2009

(51) Int. Cl. C09D 5/08; C09D 7/12

(52) U.S. Cl. 524/94; 524/80; 524/382; 524/406; 524/407; 524/417; 524/439; 524/440

(57) ABSTRACT

Magnesium rich compositions for coating metal substrates comprising a polymeric binder with up to 80 weight percent of the composition of magnesium and magnesium compounds or a mixture of magnesium and zinc and the various compounds thereof, and an effective amount of at least one corrosion inhibitor.

### STATEMENT OF GOVERNMENT INTEREST

The invention described herein may be manufactured and used by or for the Government of the United States of America for governmental purposes without the payment of any royalties thereon or therefore.

### FIELD OF THE INVENTION

This invention relates to magnesium or magnesium compounds and to mixtures of magnesium and zinc in a binder as coating compositions and more specifically to corrosion-resistant coating compositions which can be applied directly on to various substrates and particularly on to metallic substrates.

Various surfaces, and particularly metal surfaces, require the protection of coatings especially when the surfaces are exposed to a corrosive environment. Metal surfaces of aircraft, for example, are exposed to seawater which require protection from corrosion. Specifically, aircraft e.g. Navy aircraft, are exposed to seawater spray in addition to various acid-forming gases such as sad fur dioxide, carbon dioxide, etc. In addition to aircraft, various machinery and equipment in the industrial environments, where fossil fuels are used need protection against corrosion. It is important therefore that the coating be resistant to corrosion, various chemicals, the weather and at the same time be flexible and have good adhesion to the substrates. Aluminum and the aluminum alloys particularly require good adhesion between the polymeric coating and the metal surface to improve the corrosion resistance because of the various metals in the alloy which makes it more susceptible to corrosion.

In accordance with this invention, the corrosion-resistant coating compositions comprise a polymeric binder such as a polymer derived from an epoxy precursor or a polymer derived from an isocyanate e.g. hexamethylene diisocyanate (HDI) with up to 80 percent by weight of the composition of magnesium powder or magnesium compounds with or without zinc and zinc compounds and effective amounts of corrosion-inhibitors.

### SUMMARY OF THE INVENTION

This invention relates to a process and compositions for coating metal substrates particularly aluminum and aluminum alloy substrates which comprises a polymeric binder with up to about 80 percent by weight of the composition of at least one metal or metal compound selected from the group consisting of magnesium, magnesium compounds, or mixtures of said magnesium or magnesium compounds with zinc metal or zinc compounds in a ratio of about 20-50 parts by weight of Mg to 80 to 50 parts by weight of Zn and an effective amount of an inorganic and/or organic inhibitor. Specifically, the invention relates to compositions and the process for preparing corrosion-resistant coatings on metallic substrates which comprises coating said substrates with magnesium or a mixture of Mg and Zn rich coatings containing at least one corrosion inhibitor up to the inhibitors concentration limit in the coating.

The inhibitors can be added separately or in combination with one another to provide compositions that yield coatings with better corrosion resistance compared to the same composition without the corrosion inhibitors. A typical concentration of the corrosion inhibitors is approximately 1.0 to 5.0 weight percent and more typically 2.0 to 4.0 weight percent of the coating.

The initial change of the magnesium coatings after exposure to ASTM B 117 neutral salt fog and ASTM G85 Annex 4 SO₂ salt fog, is a fading of the dark grey color of the coating to light gray. This is believed to indicate the oxidation of the magnesium particles in the coating, and the formation of brucite and magnesium sulfate hexahydrate corrosion products. This color change is followed by formation of black pits in the coating surface, a darkening or dulling of the scribe and white corrosion products in the scribe.

Accordingly, it is an object of this invention to provide a magnesium rich coating composition for application to a metal substrate.

It is another object of this invention to provide magnesium or magnesium compounds with zinc metal and zinc compounds as a coating for application to aluminum and aluminum alloy substrates.

It is still a further object of this invention to provide a process for coating metal substrates with a magnesium rich corrosion-resistant coating.

These and other objects will become more apparent from a further and more detailed description of the invention.

### DESCRIPTION OF THE DRAWINGS

FIG. 1 shows AA2024-T3 panels after 930 hours exposure to SO₂ salt fog. The coating on the left was coated with a coating similar to Formulation B, but without the added strontium chromate. The next four panels arc Formulation B with 2%, 3.5%, 7% and 28% strontium chromate added.

FIG. 2 shows AA7075-T3 panels after 930 hours exposure to SO₂ salt fog. The coating on the left was coated with a coating similar to Formulation B, but without the added strontium chromate. The next four panels are Formulation B with 2%, 3.5%, 7% and 29% strontium chromate added.

FIG. 3 shows steel panels after 46 hours exposure to SO₂ salt fog. The panel on the right was coated with the coating described in Formulation C.

FIG. 4 shows AA7075-T6 panels after 425 hours exposure to SO₂ salt fog. The panel on the right was coated with the coating described in Formulation C. The panel on the left was coated with a similar coating formulated without the added strontium chromate.

FIG. 5 shows AA7075-T6 test panels after 1000 hours exposure to SO₂ salt fog. The panel on the left was coated with the coating similar to Formulation D, but without the added zinc molybdate. The next two panels were coated with Formulation D containing 1% and 3% zinc molybdate, respectively.

FIG. 6 shows AA7075-T6 test panels after 1000 hours exposure to SO₂ salt fog. The panel on the left was coated with a coating similar to Formulation E, but without the added zinc-2-mercaptobenzothiazole. The next two panels were coated with Formulation E containing 1% and 3% zinc-2-mercaptobenzothiazole, respectively.

FIG. 7 shows AA7073-T6 test panels after 1000 hours exposure to SO₂ salt fog. The panel on the left was coated with a coating similar to Formulation F, but without added zinc citrate. The panel on the right was coated with Formulation F.

FIG. 8 shows AA7075-T6 test panels after 1000 hours exposure to SO₂ salt fog. The panel on the left was coated with a coating similar to Formulation G, but without added chromium nitrate. The panel on the right was coated with Formulation G.

FIG. 9 shows AA7075-T6 test panels after 1800 hours exposure to SO₂ salt fog. The panel on the left was coated with a coating similar to Formulation H, but without added inorganic hydrotalcite clay. The next two panels were coated with Formulation H containing 1% and 3% inorganic hydrotalcite clay, respectively.

FIG. 10 shows AA2024-T3 panels after 930 hours exposure to SO₂ salt fog. The coating on the left was coated with a coating similar to Formulation J, but without the added zinc phosphate/zinc molybdate blend. The next three panels are Formulation J with 3%, 5% and 10% zinc phosphate/zinc moiybdate blend added.

FIG. 11 shows AA7075-T6 panels after 930 hours exposure to SO₂ salt fog. The coating on the left was coated with a coating similar to Formulation J, but without the added zinc phosphate/zinc molybdate blend. The next three panels are Formulation J with 3%, 5% and 10% zinc phosphate/zinc molybdate blend added.

FIG. 12 shows AA7075-T6 panels after 425 hours exposure to SO₂ salt fog. The panel on the right was coated with the coating described in Formulation K. The panel on the left was coated with a similar coating formulated without the added strontium chromate.

### DETAILED DESCRIPTION OF THE INVENTION

This invention is directed to compositions and to the process of using said compositions to resist corrosion of various metal substrates and particularly metal substrates such as aluminum and aluminum alloys. The substrates are coated with a polymeric binder comprising up to 80% by weight e.g., from 30 to 80% of at least one metal or metal compound selected from the group consisting of magnesium, magnesium compounds, and mixtures of magnesium and zinc and the various compounds thereof and an effective amount of at least one inhibitor selected from the group consisting of inorganic and organic compounds. The polymer binder can be derived from the prepolymers or oligomers of said polymers such as the isocyanates as prepolymers or the epoxy prepolymers.

The magnesium and zinc powders added to the polymeric binders have particle sizes ranging from about 0.5 to 500 microns and more likely from about 10 to 200 microns. The magnesium and zinc compounds also can contain small amounts of other metals such as zinc, manganese, barium, calcium, aluminum and the like. The magnesium and zinc powders and the various compounds thereof are added to the coating compositions in amounts ranging up to the concentration limits of the composition and generally range from about 30 to 80 percent by weight, or from about 40 to 60 weight percent of the coating.

The inhibitors are added to the coatings in effective amounts ranging from about 1.0 to 5.0 weight percent, and more typically in amounts ranging from about 2-4 weight percent. The inhibitors substantially improve the corrosion-resistance of the coating composition particularly when used to coat aluminum, and aluminum alloy substrates such as AA2024-T3 and AA7075-T6. Examples of the preferred inhibitors include strontium chromates, zinc molybdate, mercaptobenzothiazoles, zinc salts such as zinc citrate, zinc phosphates, zinc molybdate, chromium nitrate, mercaptobenzimidazole, mercaptobenzothiazole, mercaptobenzotriazole, mercaptobenzoxazole, benzotriazole, and tolytriazole. In addition to the inhibitor, the coating composition can include one or more moisture absorber or hygroscopic compound in effective amounts ranging from about 1.0 to 10 weight percent. These hygroscopic compounds are known compounds and include, for example, calcium sulfate, lithium nitrate, copper sulfate pentahydrate, silica, and the like.

The coating compositions are particularly useful for protecting aluminum and aluminum alloys since aluminum alloy substrates contain small amounts of various other metals such as Cu, Cr, Ga, Mn, Ti, Zn which renders the alloys more susceptible to corrosion. In addition, other metal substrates that can be coated to resist corrosion particularly include iron, iron alloys, copper and various alloys.

### Formulas

Formulations were tested over steel and over aluminum alloys 2024-T3 and 7075-T6. Steel panels were prepared by grit blasting with 120 grit aluminum oxide media. For aluminum test panels, formulations were tested with no conversion coating, hexavalent chromium conversion coatings, bivalent conversion coatings and non-chromium conversion coatings.

Panels to be tested without conversion coating were solvent wiped with acetone and abraded with a Scotch Brite pad and Alconox cleaner in warm tap water until a water break free surface was achieved. Panels for conversion coatings were prepared as follows: panels were prepared by solvent wiping with acetone, cleaned by immersing in Turco SmutGo NC for 3 minutes at 120° F., rinsing twice in hot tap water, deoxidized by immersion in Turco SmutGo NC for 1 minute at room temperature, rinsing twice in cold tap water, applying the conversion coating, rinsing with deionized water and allowing to dry at ambient laboratory conditions overnight. When applicable, test panels were top coated with a commercial product qualified to MIL-PRF-85285.

### Formulation B: Strontium Chromate in Magnesium-Rich Primer.

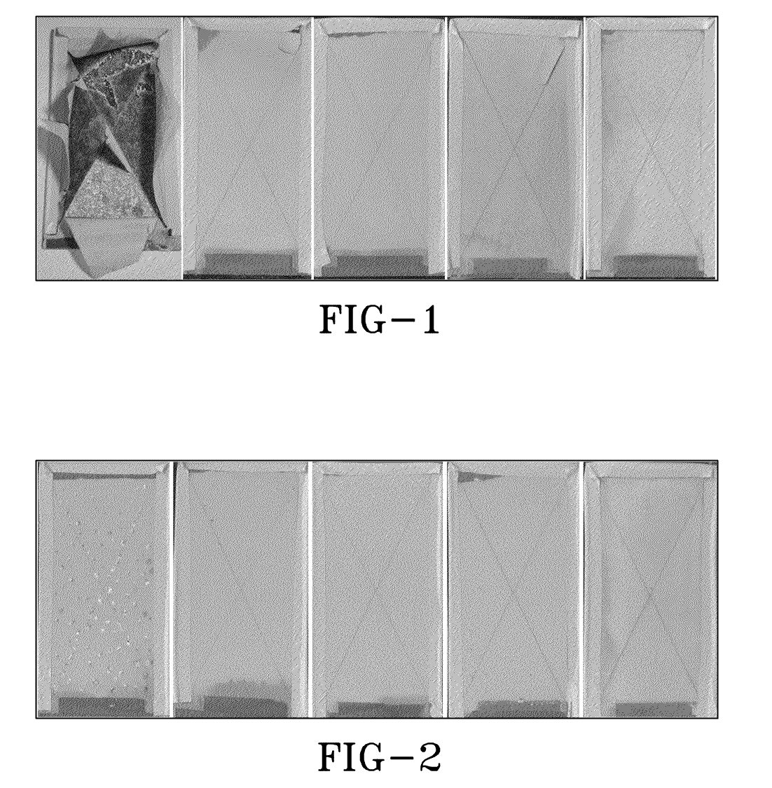

About 12.0, 20.0, 40.0 or 160.0 grams of a 70 w/w % suspension of strontium chromate in a solvent were added to about 400 grams of a mixture of magnesium particles, an epoxy resin system and a suitable solvent, yielding mixtures that were about 2%, 3.5%, 7% and 28% respectively, which were then stored until they were to be applied to test panels. At the time of application, the mixtures were combined with a curing solution consisting of an amine in a suitable solvent at a ratio of 4:1, diluted with another 1 part of a suitable solvent and applied to AA2024-T3 and AA7075-T6 test panels. The test panels were exposed to SO₂ salt fog for 930 hours. FIGS. 1 and 2 show the results on AA2024-T3 and AA7075-T6, respectively.

### Formulation C: Strontium Chromate in a Magnesium/Zinc-Rich Primer.

About 127.6 grams of a powder consisting of about 25% Mg and about 75% Zn was sifted into a mixture of 6.3 grams of a 70 w/w % suspension of strontium chromate in a solvent, 50.0 grams of diisocyanate compounds in a solvent, 1.0 grain poly alcohol in a solvent, 12.4 grams of a moisture absorber.

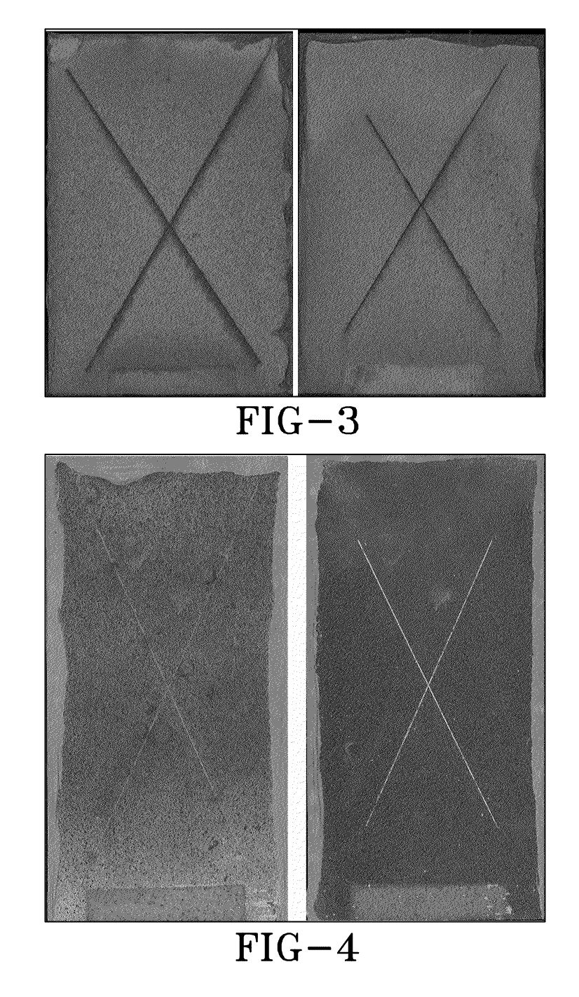

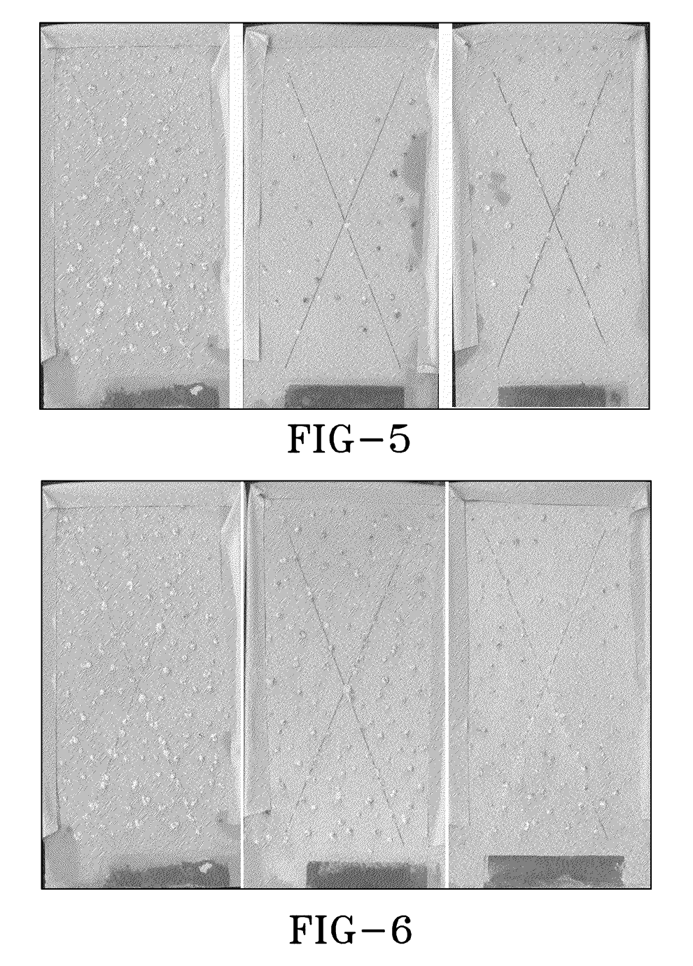

AA7075-T6 and steel panels were coated and exposed to ASTM G85, Annex 4 SO₂ salt fog. FIGS. 3 and 4 show (lie results of this coating compared to a control coating on steel panels and on AA7075-T6 panels, respectively.

### Formulation D: Zinc Molybdate in Magnesium-Rich Primer.

About 1.5, or 4.5 grams of zinc molybdate were added to about 150 grams of a mixture of magnesium particles, an epoxy resin and a suitable solvent, yielding mixtures that were about 1% and 3% respectively, which were then stored until they were to be applied to test panels. At the time of application, the mixtures were combined with a curing solution consisting of an amine in a suitable solvent at a ratio of 4:1, diluted with another 1 part of a suitable solvent and applied to AA2024-T3 and AA7075-T6 test panels. The test panels were exposed to SO₂ salt fog for 1000 hours. FIG. 5 shows the results on AA7075-T6.

Formulation E: Zinc-2-mercaptobenzothiazole in Magnesium-Rich Primer.

About 1.5, or 4.5 grams of zinc-2-mercaptobenzothiazole were added to about 150 grams of a mixture of magnesium particles, an epoxy resin and a suitable solvent, yielding mixtures that were about 1% and 3% respectively, which were then stored until they were to be applied to test panels. At the time of application, the mixtures were combined with a curing solution consisting of an amine in a suitable solvent at a ratio of 4:1, diluted with another 1 part of a suitable solvent and applied to AA2024-T3 and AA7075-T6 test panels. The test panels were exposed to SO₂ salt fog for 1000 hours. FIG. 6 shows the results on AA7075-T6.

### Formulation F: Zinc Citrate in Magnesium-Rich Primer.

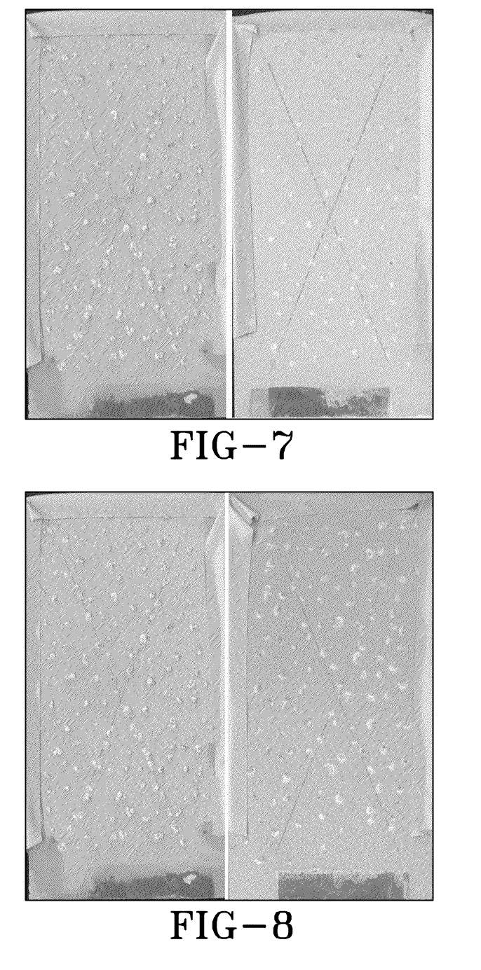

About 4.5 grams of zinc citrate were added to about 150 grams of a mixture of magnesium particles, an epoxy resin system and a suitable solvent, yielding a mixture that were about 3%, which were then stored until it was to be applied to test panels. At the time of application, the mixtures were combined with a curing solution consisting of an amine in a suitable solvent at a ratio of 4:1, diluted with another 1 part of a suitable solvent and applied to AA2024-T3 and AA7075-T6 test panels. The test panels were exposed to SO₂ salt fog for 1000 hours. FIG. 7 shows the results on AA7075-T6.

### Formulation G: Chromium Nitrate in Magnesium-Rich Primer.

About 1.5 grams of chromium nitrate were added to about 150 grams of a mixture of magnesium particles, an epoxy resin system and a suitable solvent, yielding a mixture that was about 1%, which was then stored until it was to be applied to test panels. At the time of application, the mixture was combined with a curing solution consisting of an amine in a suitable solvent and applied to AA2024-T3 and AA7075-T6 test panels. The test panels were exposed to SO₂ salt fog for 1000 hours. FIG. 8 shows the results on AA7075-T6.

Formulation H: Inorganic Hydrotalcite Clay in Magnesium-Rich Primer.

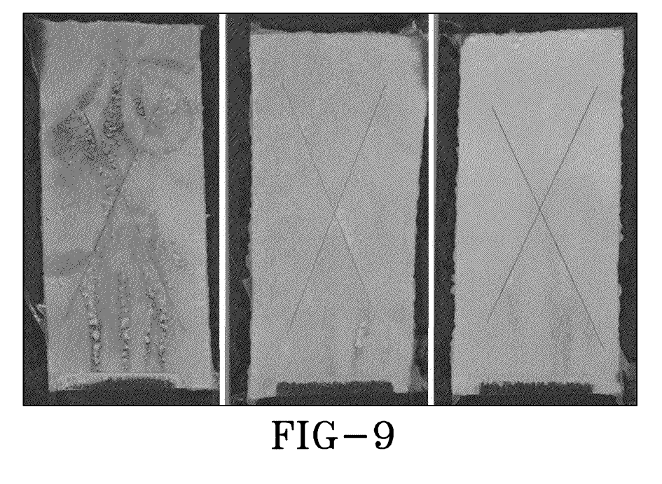

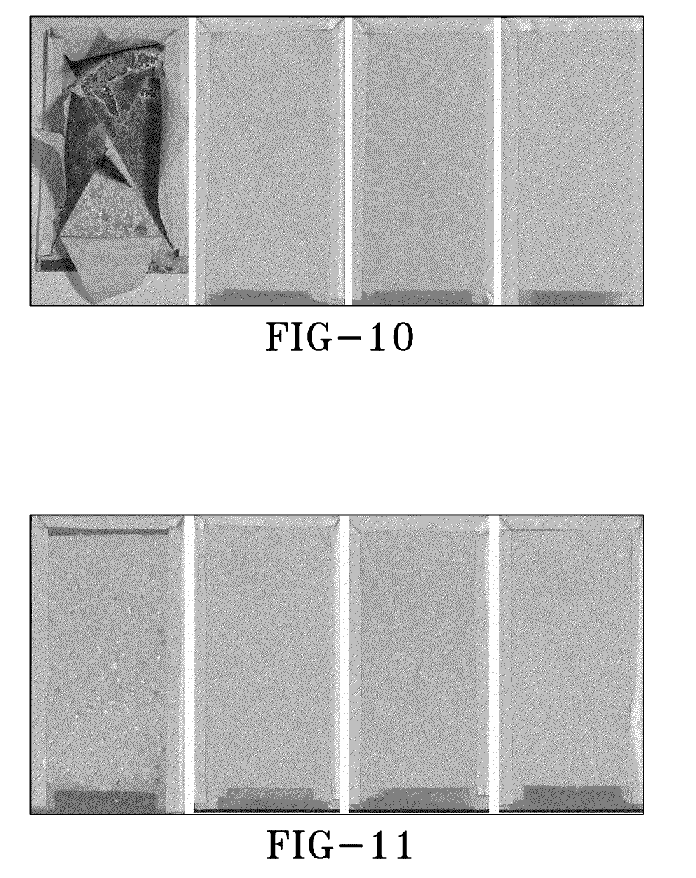

About 3.2, or 9.6 grams of inorganic hydrotalcite clay were added to about 320 grams of a mixture of magnesium particles, an epoxy resin system and a suitable solvent, yielding mixtures that were about 1% and 3% respectively, which were then stored until they were to be applied to test panels. At the time of application, the mixtures were combined with a curing solution consisting of an amine in a suitable solvent at a ratio of 4:1, diluted with another 1 part of a suitable solvent and applied to AA2024-T3 and AA7075-T6 test panels. The test panels were exposed to SO₂ salt fog for 1000 hours. FIG. 9 shows the results on AA7075-T6.

### Formulation J: Zinc Phosphate/Zinc Molybdate Blend in Magnesium-Rich Primer.

About 12.0, 20.0, or 40.0 grams of a zinc phosphate/zinc molybdate blend were added to about 400 grams of a mixture of magnesium particles, an epoxy resin system and a suitable solvent, yielding mixtures that were about 3%, 5% and 10% respectively, which were then stored until mere were to be applied to test panels. At the time of application, the mixtures were combined with a curing solution consisting of an amine in a suitable solvent at a ratio of 4:1, diluted with another 1 part of a suitable solvent and applied to AA2024-T3 and AA7075-T6 test panels. The test panels were exposed to SO₂ salt fog for 930 hours. FIGS. 10 and 11 shows the results on AA2024-T3 and AA7075-T6.

### Formulation K: Zinc Phosphate/Zinc Molybdate Blend in a Magnesium/Zinc-Rich Primer.

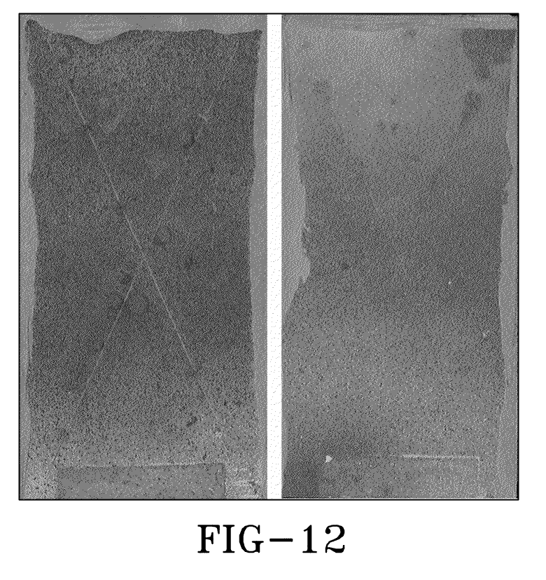

About 127.6 grams of zinc powder and 6.3 grams of a zinc phosphate/zinc molybdate blend were sifted into a mixture of 50.0 grams of diisocyanate compounds in a solvent, 1.0 gram organic prepolymer in a solvent and 12.4 grams of a moisture absorber. AA7075-T6 panels were coated with Formulation K and exposed to ASTM G85, Annex 4 SO₂ salt fog. FIG. 12 shows the results of this coating compared to a control coating on AA7075-T6 panels.

The polymers binders useful in the coatings of this invention include the polyimides and the precursors, i.e., the polyamic acids. These polymers arc well known and include polyimide precursors derived from aromatic dianhydrides, aromatic diamines and reactive crosslinkable monofunctional endcaps. Preferred dianhydrides include pyromeliticdianhydride (PMDA); 3,3′,4,4′-benzophenone tetracarboxylic dianhydride (s-BTDA); 4,4′-(hexafluoroisopropylidene)-bis(phthalic anhydride) (HFDA); 3,3′,4,4′biphenyltetracarboxylic dianhydride (BPDA); and 2,3,3′,4′-benzophenone tetracarboxylicdianhydride (a-BPDA). Various polyfunctional aromatic amines, including diamines, triamines and tetraamines and mixtures thereof can be used to prepare the polyimide precursors or polymers.

Preferred binders for the coating compositions range from about 30 to 80% by weight or 40 to 60% by weight and includes the epoxy precursors or epoxy resin compositions and the isocyanate precursors. For purposes of this invention, the term “epoxy precursors” includes epoxy compounds having one or more oxirane groups, i.e. an oxygen atom bonded to vicinal carbon atoms. Of the various precursors of epoxies suitable for purposes of this invention are the precursors that are liquid at room temperature. Specifically, the precursors of epoxy precursors include compounds which can be characterized either as saturated or unsaturated aliphatic, cycloaliphatic, aromatic or heterocyclic compounds. The curable epoxy precursors may be prepared in various solvents which include, for example, the organic solvents which escape from the composition by evaporation during the curing step. These solvents are well known and include, for example, esters such as butyl acetate, ethyl acetate, acetates of ethylene glycol monoethyl ether (Cellosolve acetate), methyl Cellosolve acetate, and the ethers alcohols.

Another preferred binder for the magnesium-rich coatings comprise the polyurethanes, and more particularly the aliphatic polyurethanes derived from the reaction of polyols and multifunctional aliphatic isocyanates and the precursors of the urethanes. The polyol is preferably used in an organic solvent e.g. toluene, xylene, n-butyl acetate, propylene glycol monomethyl ether acetate, methyl ethyl ketone, etc. The hydroxyl number of the polyol, i.e., and the isocyanate (NCO) content or the equivalent weights of the isocyanate and polyol are determined in order to obtain the desired polyurethane. The preferred polyols and isocyanates are reacted in approximately stoichiometric amounts so that the NCO to hydroxy ratio ranges from about 0.85 to 1.6 equivalent of the NCO to 1.0 equivalent of the OH. Specific compounds used in preparing the binders include, for example, isocyanates such as: diphenylmethane-4,4′-diisocyanate, toluene-2,4-diisocyanate, tetramethylene diisocyanate, decamethylene diisocyanate, ethylene diisocyanate propylene-1,2-diisocyanate, and the like. Preferred polyisocyanates include hexamethylene diisocyanate and methylene-bis-(4-cyclohexyl isocyanate) e.g., DESMODUR-N. By selecting the proper polyols and by adjusting the NCO to OH ratio, the physical properties and efficiency of the film, such as the strength of film, flexibility, chemical resistance, solvent resistance, etc. can be controlled over a wide range.

It is obvious that there are other variations and modifications which can be made with respect to this invention without departing from the spirit and scope of the invention as particularly set forth in the appendant claims.

1-27. (canceled)

28. A corrosion-resistant coating for metal substrates comprising a polymeric binder or the pre-polymer of said polymeric binder, and from about 20 to 80 weight percent of said binder of a mixture of magnesium and zinc metal powders or the compounds of magnesium and zinc having particle sizes ranging from about 0.5 to 500 microns wherein said mixture consist of about 20 to 50 parts by weight of magnesium or the compounds of magnesium to 80 to 50 parts by weight of zinc or the compounds of zinc, and from about 1.0 to 30 weight percent of the polymeric binder of at least one corrosion inhibitor selected from the group consisting of zinc salts, hydrotalcite clay, mercaptobenzothiazole, mercaptobenzimidazole, mercaptobenzotriazole, mercaptobenzoxazole, benzotriazole and tolytriazole.

29. The coating of claim 28 wherein about 1.0 to 10 weight percent of a moisture absorber, based on the weight of the binder, is added to the coating.

30. The coating of claim 29 wherein the moisture absorber is copper sulfate pentahydrate.

31. The coating of claim 28 wherein the pre-polymer of the polymeric binder is an epoxy.

32. The coating of claim 28 wherein the pre-polymer of the polymeric binder is an isocyanate.

33. The coating of claim 28 wherein the corrosion inhibitor is hydrotalcite clay.

34. The coating of claim 28 wherein the corrosion inhibitor is a zinc salt.

35. The coating of claim 28 wherein the corrosion inhibitor is mercaptobenzimidazole.

36. Process of improving the corrosion resistance of metal substrates which comprises coating said substrates with an effective amount of a coating comprising a polymeric binder or the pre-polymer of said polymeric binder, and from about 20 to 80 weight percent of said binder of a mixture of magnesium and zinc metal powders or the compounds of magnesium and zinc having a particle size of about 0.5 to 500 microns wherein said mixture consist of about 20 to 50 parts by weight of magnesium or the compounds of magnesium to 80 to 50 parts by weight of zinc or the compounds of zinc, and from about 1.0 to 30 weight percent of the binder of at least one corrosion inhibitor selected from the group consisting of zinc salts, hydrotalcite clay, mercaptobenzothiazole, mercaptobenzimidozole, mercaptobenzoxazole, tolytriazole mercaptobenzotriazole, and benzotriazole.

37. The process of claim 36 wherein about 1.0 to 10 weight percent of a moisture absorber, based on the weight of the binder, is added to the coating.

38. The process of claim 36 wherein the pre-polymer of the polymeric binder is an epoxy.

39. The process of claim 36 wherein the pr-polymer of the polymeric binder is an isocyanate.

40. The process of claim 36 wherein the corrosion inhibitor is a zinc salt.

41. The process of claim 36 wherein the corrosion inhibitor is benzotriazole.
